(19) United States
(12) Patent Application Publication
(10) Pub. No.: US 2022/0307692 A1
(43) Pub. Date: Sep. 29, 2022

(54) COMBUSTOR

(71) Applicants: TOYOTA JIDOSHA KABUSHIKI KAISHA, Toyota-shi (JP); National Institute of Advanced Industrial Science and Technology, Tokyo (JP)

(72) Inventors: Shunsuke KASUGA, Numazu-shi (JP); Mitsuaki OHTOMO, Nagakute-shi (JP); Norihiko IKI, Koriyama-shi (JP); Osamu KURATA, Tsukuba-shi (JP)

(21) Appl. No.: 17/655,764

(22) Filed: Mar. 21, 2022

(30) Foreign Application Priority Data
Mar. 23, 2021 (JP) 2021-048623

(51) Int. Cl. F23R 3/00; F23R 3/06; F23R 3/42

(52) U.S. Cl. CPC F23R 3/002; F23R 3/06; F23R 3/42; F05D 2240/35; F23R 2900/03041

(57) ABSTRACT

A combustor is configured such that an outer liner defines a combustion chamber configured such that fuel and air are supplied thereto from an upstream end side, the fuel is subjected to combustion, and a combustion gas flows out to a downstream end side, an inner liner extends to be concentric with the outer liner inside the outer liner, a sub burner is defined between the outer liner and the inner liner, a main burner is defined on the downstream end side, the fuel is supplied at an equivalence ratio and is subjected to combustion in the sub burner, and the fuel and the air are supplied to the main burner through a region provided radially inward of the inner liner and are subjected to combustion while being mixed with a burnt gas.

### CROSS-REFERENCE TO RELATED APPLICATION

This application claims priority to Japanese Patent Application No. 2021-048623 filed on Mar. 23, 2021, incorporated herein by reference in its entirety.

### BACKGROUND

### 1. Technical Field

The present disclosure relates to a structure of a combustor of a heat engine, such as a gas turbine engine or a boiler, and more particularly to a structure (a burner) causing combustion in the combustor.

### 2. Description of Related Art

For a combustor that obtains energy through combustion of fuel of a gas turbine engine, a boiler, or the like, various structures have been proposed in the related art for improvement of combustion efficiency and energy efficiency and suppression of the amount of discharge of NOx, CO, unburnt hydrocarbons, and the like. For example, proposed in Japanese Unexamined Patent Application Publication No. 2020-51640 (JP 2020-51640 A) are suppressing generation of NOx by providing a nozzle hole for ejection of fuel to two positions, which are the vicinity of a tip end of a pilot nozzle and a position upstream of the vicinity of the tip end, in the pilot nozzle so that a distance by which a burnt gas stays at a high-temperature region and a time for which the burnt gas stays at the high-temperature region are shortened in a configuration in which the pilot nozzle that protrudes toward a downstream side from a central region of a main nozzle ejecting an amount of main fuel and that forms a flame is disposed in a circumferential shape at an upstream end of a combustion tube in which fuel is subjected to combustion and suppressing an increase in amount of unburnt hydrocarbons and CO by favorably mixing fuel ejected on the downstream side, the burnt gas from an upstream side, air, and the like with each other within a short distance and increasing the uniformity of fuel concentration to suppress an increase in amount of unburnt hydrocarbons and CO while suppressing generation of NOx in a combustor for a gas turbine. Proposed in Japanese Unexamined Patent Application Publication No. 2008-196831 (JP 2008-196831 A) are separating a diffusion combustion region and a premixed combustion region from each other and improving an ignition property, a flame retention property, and combustion stability at a low-load time in the case of a configuration in which a combined combustion method obtained by combining a diffusion combustion method, which is excellent in ignition performance and flame retention performance, and a lean premixed combustion method, with which it is possible to effectively reduce the amount of generation of NOx, with each other is used for a combustion chamber of a combustor of a gas turbine engine. Disclosed in Japanese Unexamined Patent Application Publication No. 2003-262336 (JP 2003-262336 A) is a configuration in which a lean air-fuel mixture of fuel and air is ejected from an air-fuel premixture ejection pipe to a burnt gas ejected from a burner of which a discharge port is open in a combustion chamber and the lean air-fuel mixture is subjected to combustion by means of a high-temperature burnt gas in a gas turbine combustor so that both of a high combustion efficiency and a low NOx discharge concentration property are achieved for a wide output range without a mechanism changing the flow rate of air for combustion. Furthermore, proposed in Japanese Unexamined Patent Application Publication No. 11-101435 (JP 11-101435 A) is providing a first burner that ejects fuel and ejects air such that the air swirls, a plurality of second burners that is disposed around the first burner and supplies an air-fuel premixture of air and fuel to a combustion chamber, an annular partition wall that is disposed outside the first burner, is disposed inward of an air-fuel premixture stream of the second burners, is formed such that the sectional area in a radial direction increases over a downstream side of the combustion chamber, and includes a surface inclined with respect to a central axis of the combustion chamber, and a plurality of air ejection ports that is disposed in the inclined surface of the annular partition wall at intervals and through which air is ejected in a direction along the central axis of the combustion chamber in the combustion chamber of a gas turbine combustor to which fuel and air are supplied, so that generation of large combustion vibration is prevented, the amount of discharge of NOx is reduced for a wide operating range, and combustion can be performed stably. To sum up, it can be said that various attempts to improve the configuration of a combustor of a gas turbine engine, a boiler, or the like in the related art have been made to suitably achieve lean combustion with a lean air-fuel mixture without an overheated state.

### SUMMARY

Meanwhile, in a viewpoint of prevention of global warming and decarbonization, introduction of fuel containing no carbon or renewable energy is desired. In one of such energies, hydrogen can be a medium. However, hydrogen is a gas at room temperature and is not suitable for mass storage and transportation. Therefore, using ammonia (NH₃) as a hydrogen energy carrier, has been conceived, for example. In this regard, since the specific latent heat of ammonia is large and the combustible equivalence ratio range (combustible range) of ammonia is narrow in comparison with hydrocarbon fuel or fossil fuel, it is difficult to maintain combustion stability over the entire operating range corresponding to a fluctuation in load on a heat engine. Particularly, in the case of a liquefied gas, such as liquid ammonia of which the specific latent heat is large, the temperature of the liquefied gas is decreased when the liquefied gas is supplied to a combustion place so that a flame is likely to go out and the range of equivalence ratios for stable combustion is further narrowed. Therefore, in a case where fuel like liquid ammonia of which the specific latent heat is large and the combustible equivalence ratio range is narrow is used for a combustor of a gas turbine engine or a boiler, a new configuration in which such fuel can be stably subjected to combustion over a wider operating range corresponding to a fluctuation in load on a heat engine is advantageous.

The present disclosure provides a new configuration with which it is possible to stably achieve a combustion state over a wide operating range in a case where fuel like liquid ammonia of which the specific latent heat is large and the combustible equivalence ratio range is narrow is used as fuel in a combustor of a heat engine, such as a gas turbine engine or a boiler.

In addition, it is preferable that the new configuration of the combustor as described above is as simple as possible. Therefore, the present disclosure provides a combustor as described above of which the configuration is as simple as possible.

An aspect of the present disclosure relates to a combustor of a heat engine that obtains energy through combustion of liquefied gas fuel or liquid fuel. The combustor includes a tubular outer liner and a tubular inner liner. The outer liner includes an upstream end and a downstream end, the outer liner defining a combustion chamber that is configured such that fuel and air are supplied to the combustion chamber from the upstream end side, the fuel is subjected to combustion in the combustion chamber, and a combustion gas flows out to the downstream end side. The inner liner extends to be concentric with the outer liner from the upstream end side by a length shorter than the length of the outer liner inside the outer liner. A donut-shaped sub burner is defined between the outer liner and the inner liner in the combustion chamber, a main burner is defined between an end of the inner liner that is close to the downstream end and the downstream end of the outer liner, the fuel is supplied at an equivalence ratio at which a flame is retained and a combustion state is maintained throughout the operation of the heat engine and is subjected to combustion in the sub burner, a burnt gas resulting from the combustion flows out to the main burner, and the fuel and the air are supplied to the main burner through a region provided radially inward of the inner liner and are subjected to combustion in the main burner while being mixed with the burnt gas from the sub burner.

In the above-described configuration, the “heat engine” is an internal combustion engine or an external combustion engine, such as a gas turbine engine or a boiler, and may be any engine that obtains heat energy through combustion of fuel. Liquefied gas fuel or liquid fuel may be any fuel that is liquid during storage, transportation and distribution and turns into droplets or a gas when the fuel is supplied to the combustion chamber. Particularly, as mentioned above, the combustor according to the embodiment of the present disclosure is configured such that even liquid or a liquefied gas, such as liquid ammonia, of which the specific latent heat is large and the combustible equivalence ratio range is narrow, is subjected to favorable combustion as fuel. The “tubular outer liner” and the “tubular inner liner” may be formed of a heat-resistant material commonly used in this technical field. Regarding the “combustion chamber” defined inside the outer liner, air and fuel flow into the combustion chamber from one end, that is, an upstream end and turn into a combustion gas through combustion. The combustion gas flows out to the other end, that is, a downstream end and generates heat energy. In the combustion chamber, particularly in the case of the present disclosure, a donut-shaped space is defined between the outer liner and the inner liner as the “sub burner” on an upstream side and the “main burner” in which main fuel combustion occurs is continuously defined downstream of the sub burner. In addition, in the sub burner, fuel is supplied at an equivalence ratio at which a flame is retained and a combustion state is maintained throughout the operation of the heat engine and is subjected to combustion and a burnt gas resulting from the combustion flows out to the main burner defined downstream of the outer liner. In the main burner, fuel and air are supplied through the region provided radially inward of the inner liner and are subjected to combustion while being mixed with the high-temperature burnt gas from the sub burner. Note that “throughout the operation of the heat engine” means the entire period during which the heat engine is in operation and combustion of fuel in the combustor needs to be performed (in the present specification, “entire” also means “almost entire”). A portion of the outer liner that defines an outer side of the sub burner and a portion of the outer liner that defines the main burner may be integrally formed with each other and may be formed separately from each other (it should be understood that the sub burner and the main burner may be defined by a first outer liner and a second liner respectively and such a case also falls within the scope of the present disclosure).

In the case of the above-described configuration according to the embodiment of the present disclosure, in the sub burner formed on an upstream side of the combustion chamber, fuel is supplied after adjustment such that an equivalence ratio, at which a flame is reliably retained and fuel is subjected to combustion substantially always during the operation of the heat engine is achieved even if the fuel is fuel of which the specific latent heat is large and the combustible equivalence ratio range is narrow like liquid ammonia. In this case, the fuel is subjected to combustion always in the sub burner, the high-temperature burnt gas flows out from the sub burner to the main burner formed on a downstream side of the combustion chamber, and the high-temperature burnt gas is mixed with fuel and air supplied to the main burner to raise the temperature of the fuel and the air. Therefore, it is expected that a range of equivalence ratios in which combustion occurs stably is widened and ignition and combustion occur while being barely influenced by a temperature decrease caused by evaporation even if the supplied fuel is fuel of which the specific latent heat is originally large and the combustible equivalence ratio range is narrow and thus is difficult to burn as it is and that a stable combustion state is achieved in the main burner even if the operating state fluctuates corresponding to a fluctuation in load on the engine. In addition, in the above-described configuration, since the sub burner is formed in a donut-like shape while being provided upstream of the main burner, fuel and air to be supplied to the main burner are supplied to the main burner through the inside of the donut-like shape, that is, a region provided radially inward of the inner liner. Therefore, there is an advantageous effect that a structure for supply of fuel and air to the main burner is simplified and the temperature of the fuel and the air supplied to the main burner rises since the high-temperature burnt gas from the sub burner proceeds to the main burner such that the high-temperature burnt gas surrounds the fuel and the air supplied to the main burner. Accordingly, in the case of the configuration of the combustor according to the embodiment of the present disclosure, it is expected that a state where fuel is reliably subjected to stable combustion can be achieved for a wide engine operating range even in a case where fuel of which the specific latent heat is large and the combustible equivalence ratio range is narrow like liquid ammonia used as the fuel.

Other objects and advantages of the present disclosure will be made apparent from the following description of a preferred embodiment of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic sectional view showing the basic configuration of a combustor according to an embodiment as seen in a lateral direction;

FIG. 1B is a diagram showing the configuration of an aspect of a process of determining the flow rate of fuel supplied in the combustor according to the embodiment in the form of a block diagram;

FIG. 1C is a diagram showing the configuration of another aspect of the process of determining the flow rate of fuel supplied in the combustor according to the embodiment in the form of a block diagram;

FIG. 2 is a schematic sectional view showing the combustor according to the present embodiment that is configured such that a preliminary room, in which fuel and air supplied to a main burner are mixed with each other, is provided, as seen in the lateral direction;

FIG. 3 is a schematic sectional view showing the combustor according to the present embodiment that is configured such that fuel supplied to the sub burner is discharged to the sub burner after flowing through a flow path in an inner liner, as seen in the lateral direction;

FIG. 4 is a schematic sectional view showing the combustor according to the present embodiment that is configured such that an outer liner is provided with a hole through which air directly flows to the main burner, as seen in the lateral direction;

FIG. 5 is a schematic sectional view showing the combustor according to the present embodiment that is configured such that an outlet from the preliminary room in which fuel and air supplied to the main burner are mixed with each other to the main burner is narrowed, as seen in the lateral direction; and

FIG. 6 is a schematic sectional view showing the combustor according to the present embodiment that is configured such that an outlet from the sub burner to the main burner is narrowed, as seen in the lateral direction.

### DETAILED DESCRIPTION OF EMBODIMENTS

Basic Configuration of Combustor

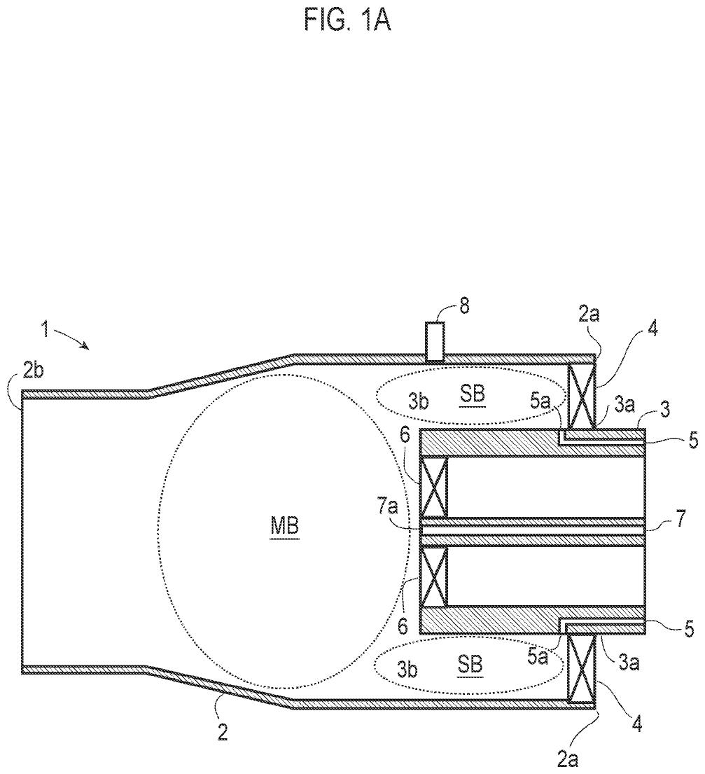

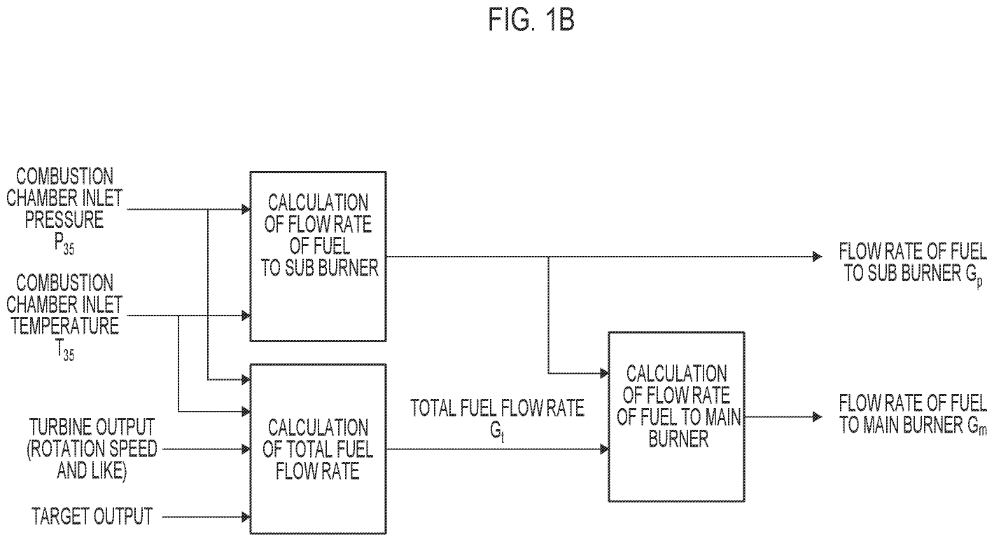

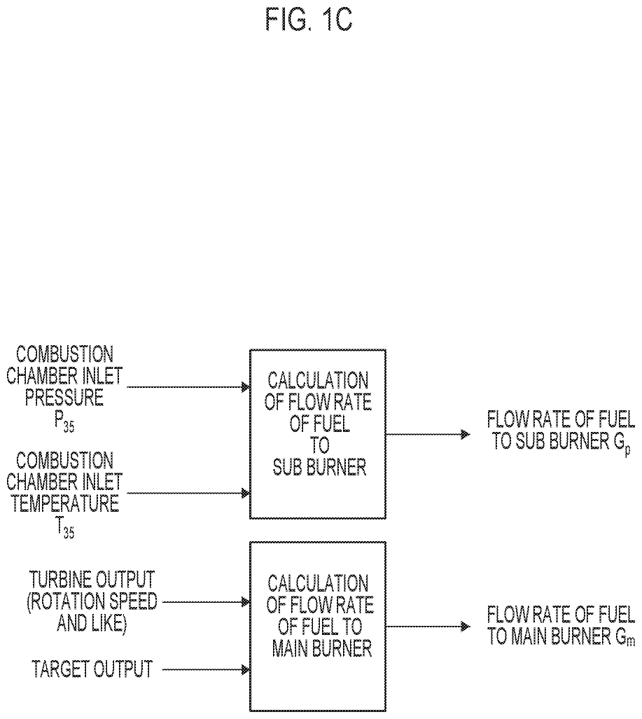

A combustor of the present embodiment is used as a combustor of a heat engine, such as a gas turbine engine or a boiler which obtains heat energy generated through combustion of fuel and air. The fuel may be a liquefied gas fuel or other liquid fuel. As shown in FIG. 1A, in the basic configuration of a combustor 1 of the present embodiment, a combustion chamber (SB, MB) is defined with a tubular outer liner 2 serving as an outer wall, the outer liner 2 including an upstream end 2a and a downstream end 2b. The outer liner 2 may be formed of a material such as a heat-resistant metal commonly used in this technical field and typically has a cylindrical shape (in the present specification, “cylindrical” also means “substantially cylindrical”). However, the outer liner 2 may have an elliptical tubular shape or a rectangular tubular shape. In the combustion chamber, an inner liner 3 extends to be approximately concentric with the outer liner 2 from the upstream end 2a side of the outer liner 2 by a distance shorter than the length of the outer liner 2 inside the outer liner 2, a donut-shaped sub burner (sub combustion place) SB is defined between the outer liner 2 and the inner liner 3, and a main burner (main combustion place) MB is defined by the outer liner 2 at a position between a downstream end 3b of the inner liner 3 and the downstream end 2b of the outer liner 2. The inner liner 3 may also be formed of a material such as a heat-resistant metal commonly used in this technical field and typically has a cylindrical shape. However, the inner liner 3 may have an elliptical tubular shape or a rectangular tubular shape. In addition, an upstream end 3a side of the inner liner 3, an air supply port 4 and a fuel supply path 5 are provided and are configured such that air and fuel are introduced into the sub burner SB. Meanwhile, air is introduced into the main burner MB via an air supply port 6 through a space provided radially inward of the inner liner 3 and fuel is sent into the main burner MB via a fuel supply port 7a through a fuel supply path 7. Each of the air supply ports 4, 6 may be configured to have a structure in which air can swirl and may be configured such that an air stream is caused to swirl when the air stream passes through the air supply ports 4, 6 and air and fuel are mixed with each other more favorably in a combustion place. A structure in which air can swirl is achieved by providing an inclined blade structure in a flow path, or by drilling an inclined flow hole. Note that in the sub burner SB, an ignition plug 8 is provided in order to assist the first fuel ignition (the ignition plug is generally operated at a time when the combustor is started and once a flame is generated, combustion continues even if the ignition plug 8 is not operated). In the drawing, a portion of the outer liner 2 that defines an outer side of the sub burner SB and a portion of the outer liner 2 that defines the main burner MB are integrally formed with each other. However, the portions of the outer liner 2 may also be formed separately from each other. A key point is that the sub burner SB is defined upstream of the main burner MB.

In addition, in the above-described configuration, the flow rate of fuel supplied to the sub burner SB is adjusted such that an equivalence ratio at which a flame is retained and a stable combustion state is maintained throughout the operation of the heat engine regardless of a load on the heat engine or the operating state of the heat engine is achieved. Therefore, in the sub burner SB, a flame is retained substantially always during the operation of the heat engine such that combustion continues and a high-temperature burnt gas flows to the main burner MB from the sub burner SB and in the main burner MB, the high-temperature burnt gas from the sub burner SB is mixed with fuel and air directly introduced into the main burner MB and raises the temperature of the fuel and the air so that the fuel becomes likely to be evaporated and thus it is expected that a range of equivalence ratio in which combustion of fuel is stable is widened. In the case of the above-described configuration, stable combustion is maintained in the combustor even if the amount of supply of fuel fluctuates corresponding to a fluctuation in load on the heat engine. Therefore, the heat engine can be operated over a wider operating range and particularly, even liquid or a liquefied gas, such as liquid ammonia, of which the specific latent heat is large and the combustible equivalence ratio range is narrow, can be used as fuel of the combustor for a wider operating range.

It needs to be understood that a donut-shaped outer wall of the sub burner SB is defined by the outer liner 2, an inner wall of the sub burner SB is defined by the inner liner 3, and a space between the upstream end 3a and the downstream end 3b is not open in the above-described configuration and thus it is easy to adjust an equivalence ratio such that a flame is retained and a stable combustion state is maintained in the space. That is, since the donut-shaped sub burner SB is defined while being separated from a spatial region provided radially inward of the sub burner SB by the inner liner 3, it is easy to adjust the flow rate of fuel with respect to the flow rate of air sent into the sub burner SB to achieve the above-described equivalence ratio. In addition, in the case of a configuration in which the sub burner SB that applies a high-temperature burnt gas to a main burner has a donut-like shape and fuel and air to be subjected to combustion in the main burner MB are introduced into the main burner MB through a central region of the donut-like shape (a region that is not the sub burner SB), a high-temperature burnt gas from the sub burner SB is applied to surround a region in the main burner MB into which the fuel and the air are introduced. Therefore, the fuel and the air are more favorably mixed with the burnt gas and the temperature of the fuel and the air is raised. Therefore, it is expected that a more stable combustion state can be achieved. Furthermore, in order to cause combustion to spread evenly in the main burner at the time of introduction of the fuel and the air into the main burner, it is preferable to introduce the fuel and the air to the vicinity of a central axis of the main burner. Therefore, a configuration in which the fuel and the air are introduced into the main burner through the central region of the donut-like shape is also advantageous in that supplying the fuel and the air along the central axis (in the present specification, “along the central axis” also means “substantially along the central axis”) of the main burner can be achieved with a simple structure (in a case where the sub burner SB does not have the donut-like shape and the fuel and the air cannot be introduced into the main burner through the central region of the donut-like shape, although the fuel and the air are introduced evenly from the vicinity of the main burner, a structure of the configuration is complicated and there is a possibility of an increase in manufacturing cost).

Fuel Flow Rate Control

As described above, in the combustor of the present embodiment, the sub burner SB includes a fuel supply system independent of the main burner MB and thus combustion can be performed under a stable fuel combustion condition regardless of operating conditions of the heat engine. That is, the flow rate of fuel supplied to the sub burner SB needs to be determined with respect to the amount of air flowing into the sub burner SB such that an equivalence ratio at which a flame is retained and a stable combustion state is maintained is achieved and since the amount of air is determined by the pressure and the temperature of air at an inlet of the sub burner SB, the flow rate of fuel to the sub burner SB may be determined based on the pressure and the temperature of the air. Meanwhile, since the flow rate of fuel to the sub burner SB is determined regardless of the operating conditions of the heat engine although the flow rate of fuel supplied to the entire combustor is determined by the operating conditions of the heat engine, the flow rate of fuel to the main burner MB is a flow rate obtained by subtracting the flow rate of fuel to the sub burner SB from the flow rate of fuel supplied to the entire combustor.

Accordingly, as one aspect, at the time of control of the flow rate of fuel to the sub burner SB and the main burner MB, specifically, a flow rate Gₚ of fuel to the sub burner SB may be determined by any method based on a pressure P₃₅ and a temperature T₃₅ of air at an inlet of the combustion chamber (the sub burner SB) as shown in the form of a block diagram in FIG. 1B. For example, in an embodiment, a map for determination of the sub burner fuel flow rate Gₚ for application of the optimum equivalence ratio in which variables are the temperature T₃₅ and the pressure P₃₅ of the air may be prepared in advance through an experiment or the like and in the operation of the heat engine, the sub burner fuel flow rate Gₚ may be applied through map calculation by using the temperature T₃₅ and the pressure P₃₅ sequentially measured. With regard to the flow rate Gₘ of fuel to the main burner MB, first, a total fuel flow rate Gt is determined such that the output (rotation speed, torque) of the heat engine becomes a target output as needed. In this regard, the total amount of fuel to be supplied may be limited such that the temperature of a combustor outlet (a turbine inlet) does not become excessively high. Therefore, specifically, the total fuel flow rate Gₜ may be determined such that the output becomes a target value and the temperature of the combustor outlet (the turbine inlet) does not become excessively high by monitoring the output of the heat engine, the target output, and the temperature of the combustor outlet (the turbine inlet). Since the temperature of the above-described combustor outlet (the turbine inlet) is determined by adding the amount of heat generation of fuel to the heat amount of air at the inlet of the combustion chamber in fact, the temperature of the above-described combustor outlet (the turbine inlet) can be estimated from the temperature T₃₅ and the pressure P₃₅ of air measured at the inlet of the combustion chamber in consideration of the amount of heat generation of fuel flowing into the combustion chamber. Therefore, the total amount of fuel to be supplied may be limited based on the temperature T₃₅ and pressure P₃₅ of air at the inlet of the combustion chamber as shown in the drawing without directly measuring the temperature of the combustor outlet (the turbine inlet). Note that, the total fuel flow rate Gₜ may be subjected to feedback control in order to maintain a rotation speed and an output.

Meanwhile, the sub burner fuel flow rate Gₚ is determined based on the temperature and the pressure of inflow air without referring to the operating state (the rotation speed or the like) of the heat engine and a fuel flow rate that is adjusted to cause a load on the heat engine to fluctuate is a main burner fuel flow rate Gₘ. Therefore, the main burner fuel flow rate Gₘ may be adjusted by feedback control of the operating state of the heat engine, substantially. Accordingly, the main burner fuel flow rate Gₘ may be adjusted by referring to the output of the heat engine, such as a turbine rotation speed and a torque, such that the target output is achieved, as shown in FIG. 1C. Note that in the case of a gas turbine engine, the sub burner fuel flow rate Gₚ may be determined based on an engine rotation speed or the like as long as a combustion state of the sub burner is maintained.

Configuration Provided with Preliminary Room Where Fuel and Air to Main Burner Are Mixed with Each Other

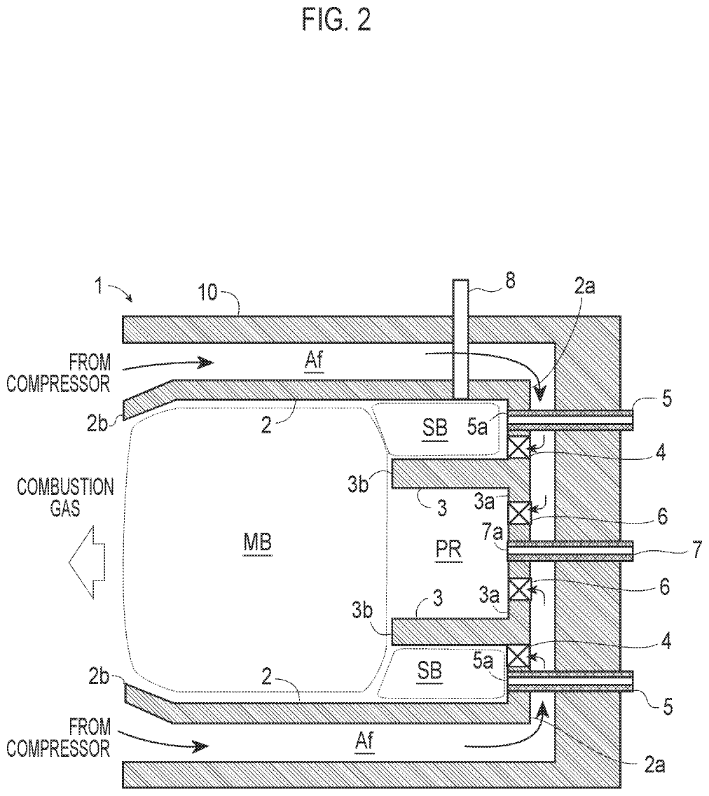

The fuel and the air to the main burner MB are supplied through a region provided radially inward of the donut-shaped inner liner 3 of the sub burner SB as described above and a more stable combustion state can be achieved in a case where the fuel and the air are mixed with each other when the fuel and the air are introduced into the main burner MB. Therefore, as shown in FIG. 2, the fuel and the air to the main burner MB may be introduced at a preliminary room PR, which is the region provided radially inward of the inner liner 3, and may flow out to the main burner MB after being mixed with each other at the preliminary room PR. In the embodiment, specifically, the air supply port 6, through which air flowing from a compressor or the like through an air flow path Af defined between a casing 10 and the outer liner 2 is supplied at the upstream end 3a of the inner liner 3, and an opening (main burner fuel supply port) 7a of the main burner fuel supply path 7 may be provided on the upstream end 3a side of the inner liner 3, fuel and air may be discharged to the preliminary room PR, and the fuel and the air may be mixed with each other at the preliminary room PR. Note that, since the preliminary room PR is defined by the inner liner 3 and the inner liner 3 receives the heat of the sub burner SB, the fuel and the air are somewhat heated by the inner liner 3 when being mixed with each other and thus it is expected that a combustion state is further stabilized when the fuel and the air are discharged to the main burner MB.

Configuration Where Fuel Supplied to Sub Burner SB is Heated

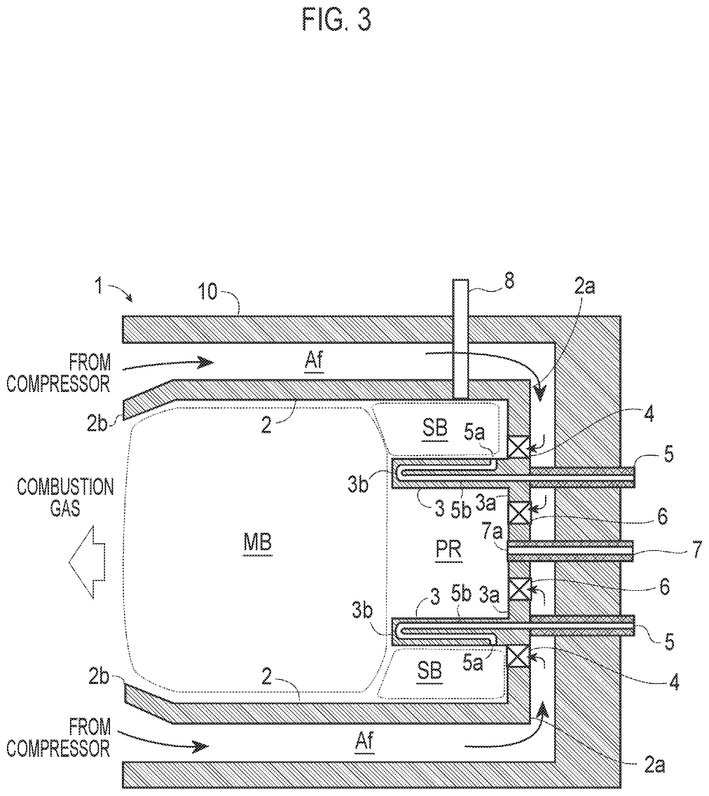

In a case where fuel is liquid fuel, such as liquid ammonia of which the specific latent heat is large, heat is taken away because the fuel is evaporated before combustion. Therefore, the temperature of a combustion place is lowered in a case where the fuel is introduced into the combustion place in the form of liquid, particularly, in the form of low-temperature liquid. Therefore, in the above-described configuration, the fuel to the sub burner SB may be introduced into the sub burner SB after being heated before the introduction, preferably, after being evaporated or brought into a state of being likely to be evaporated. Specifically, as schematically shown in FIG. 3, a supply path 5b for fuel to the sub burner SB may be drilled inside the inner liner 3 and the fuel may be discharged to the sub burner SB after flowing through the inner liner 3. In the case of the above-described configuration, the fuel receives combustion heat of the sub burner SB from the inner liner 3 and is evaporated before the fuel is discharged to the sub burner SB and thus it is possible to suppress a decrease in temperature that occurs after the fuel is discharged. In addition, since the fuel takes away latent heat of evaporation in the inner liner 3, the inner liner 3 is cooled and it is also possible to restrain the inner liner 3 from being overheated, which is advantageous.

Configuration Where Outer Liner is Provided with Air Hole Communicating with Main Burner

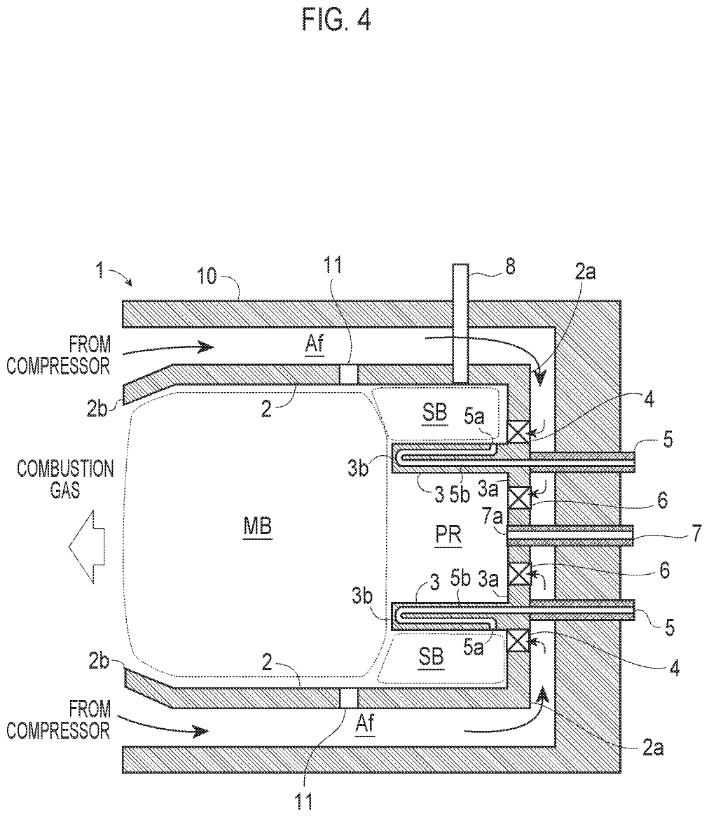

With reference to FIG. 4, an air hole 11 that leads to the main burner MB may be provided at the outer liner 2 defining the air flow path Af, as shown in the drawing. In the case of the above-described configuration, the mixing of fuel, air, and a burnt gas in the main burner MB is accelerated by air flowing into the main burner MB via the air hole 11 and thus it is expected that the efficiency of combustion is improved.

Configuration Where Outlet of Preliminary Room is Narrow

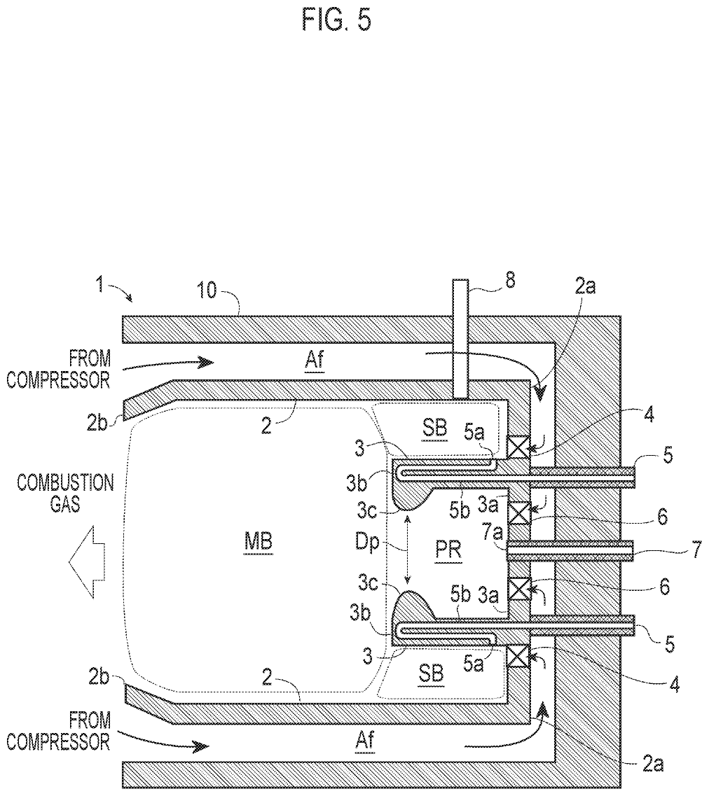

With reference to FIG. 5, as shown in the drawing, a bulge portion 3c that protrudes radially inward may be provided at the downstream end 3b of the inner liner 3 such that a diameter Dp of an outlet from the preliminary room PR, which is a region provided radially inward of the inner liner 3, to the main burner MB becomes smaller than the inner diameter of the preliminary room PR that is provided upstream of the outlet. In the case of the above-described configuration, the mixing of air and fuel supplied to the main burner MB is accelerated and particularly, in the case of liquid fuel, evaporation is also accelerated. Therefore, it is expected that the efficiency of combustion in the main burner MB is improved.

Configuration Where Outlet of Sub Burner is Narrow

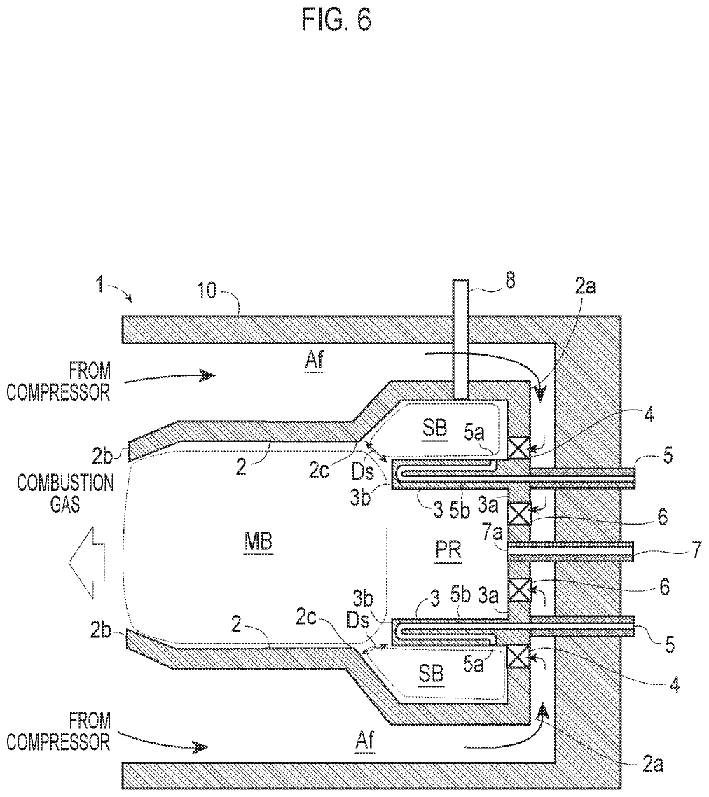

With reference to FIG. 6, as shown in the drawing, the outer liner 2 may be deformed such that an inner diameter 2c of the outer liner 2 becomes small in the vicinity of an outlet of the sub burner SB and thus an area Ds of an outlet from the sub burner SB to the main burner MB becomes smaller than the sectional area of the sub burner SB. In the case of the above-described configuration, the flow velocity of a burnt gas at the outlet of the sub burner SB is increased and the mixing of air and fuel supplied to the main burner MB is accelerated. Therefore, it is expected that the efficiency of combustion is improved.

Accordingly, in the above-described embodiment, the sub burner formed in the donut-like shape is configured on an upstream side in a fluid flowing direction and the main burner is configured on a downstream side as fuel places in the combustor of the heat engine. A combustion state is maintained stably regardless of the operating conditions of the heat engine in the sub burner, the high-temperature burnt gas obtained in the sub burner is introduced into the main burner, and thus a combustion state is stabilized even in a wider range of equivalence ratios which fluctuates depending on the operating conditions. As described above, in the present embodiment, the sub burner is defined between the outer liner and the inner liner and thus equivalence ratio adjustment can be performed such that a combustion state can be maintained stably more easily. In addition, since the donut-shaped sub burner is provided upstream of the main burner, a temperature rise at the main burner caused by the high-temperature burnt gas is evenly achieved and a structure for introduction of fuel and air to the main burner is simplified. In the present embodiment, fuel is reliably subjected to combustion in the sub burner under a condition under which stable combustion is likely to occur and the state of combustion is transmitted to the main burner so that a stable combustion state is achieved. Therefore, as mentioned above, non-flammable fuel, such as ammonia (NH₃), which is supposed to be used as a hydrogen energy carrier, can also be subjected to combustion stably.

Although the above description has been made in relation to the embodiment of the present disclosure, it is obvious to those skilled in the art that a lot of corrections and modifications can be easily made and the present disclosure is not limited to the embodiment described above and can be applied to various devices without departing from the concept of the present disclosure.

In the above-described configuration according to the embodiment of the present disclosure, fuel supplied to the sub burner is supplied such that an equivalence ratio at which a flame is reliably retained and a state where the fuel is subjected to combustion regardless of the operating state of the heat engine is achieved as described above and adjustment of the amount of fuel that causes a fluctuation in output in accordance with a load on the heat engine is achieved by increasing and decreasing the amount of fuel supplied to the main burner. Therefore, the amount of fuel supplied to the main burner may be increased or decreased corresponding to a load on the heat engine. In addition, fuel supplied to the sub burner is supplied at an equivalence ratio at which a combustion state is maintained as described above and the amount of air at that time depends on the pressure and the temperature of air at an inlet of the sub burner. Therefore, the amount of fuel supplied to the sub burner may be determined based on the pressure and the temperature of air supplied to the sub burner at the inlet of the sub burner. Note that in a case where the combustor is applied to a gas turbine engine, the amount of fuel supplied to the sub burner may be determined based on the engine rotation speed.

In the above-described combustor according to the embodiment of the present disclosure, for stabilization of combustion in the sub burner, it is favorable that the temperature of fuel supplied to the sub burner is made high before the fuel is supplied. In addition, it is more preferable that the fuel is discharged to the sub burner after being evaporated (in a case where the fuel is introduced in the form of liquid, a temperature decrease may occur due to latent heat of evaporation). In this regard, in the configuration according to the embodiment of the present disclosure, the sub burner is formed in a donut-like shape between the outer liner and the inner liner and since the inner liner extends inside the combustion chamber, the temperature of the inner liner is made considerably high (the outer liner is cooled by being brought into contact with air before supply to the combustion chamber and heat loss is likely to occur since the outer liner is provided outside the combustion chamber). Therefore, in the combustor according to the embodiment of the present disclosure, the inner liner may be configured to include a flow path inside the inner liner for fuel supplied to the sub burner and the fuel supplied to the sub burner may be discharged to the sub burner after flowing through the flow path while being heated by heat from the sub burner. In the case of the above-described configuration, it is possible to raise the temperature of the fuel supplied to the sub burner or to evaporate the fuel before introduction into the sub burner (it is possible to avoid a temperature decrease caused by latent heat of evaporation). In addition, it is possible to cool the inner liner by means of a temperature rise or evaporation of the fuel and to restrain the inner liner from being overheated.

In addition, in the above-described combustor according to the embodiment of the present disclosure, fuel and air to the main burner are supplied through the region provided radially inward of the inner liner and for more stable combustion, it is preferable that the fuel and the air are appropriately mixed with each other before the fuel and the air are supplied to the main burner. Therefore, in the above-described configuration according to the embodiment of the present disclosure, fuel and air supplied to the main burner may flow out to the main burner while being discharged to a preliminary room defined radially inward of the inner liner and being mixed with each other. In addition, the preliminary room defined radially inward of the inner liner may be formed such that a diameter of a downstream end that continues to the main burner is smaller than a diameter on an upstream side and an outlet from the preliminary room to the main burner may be narrowed. In this case, fuel and air are more favorably mixed with each other in the preliminary room and there is also an advantageous effect that a temperature rise or evaporation of the fuel is accelerated due to heat from the inner liner.

Furthermore, in the above-described configuration, an opening area of a downstream end of the sub burner that continues to the main burner may be smaller than an opening area on an upstream side and an outlet from the sub burner to the main burner may be narrowed. In this case, the flow velocity of a burnt gas flowing out from the sub burner to the main burner becomes high and the mixing of fuel, air, and the burnt gas in the main burner is accelerated, which contributes to achievement of more stable combustion.

Furthermore, in the above-described configuration, an air hole through which air directly flows into the main burner may be formed in the outer liner. In this case, due to air inflow through the air hole, the mixing of fuel, air, and a burnt gas in the main burner is accelerated, which contributes to achievement of more stable combustion.

As mentioned above, using the above-described combustor according to the embodiment of the present disclosure is particularly advantageous in a case where liquid or a liquefied gas of which the specific latent heat is large and the combustible equivalence ratio range is narrow is used as fuel. Therefore, the fuel supplied to the main burner may be fuel containing liquid ammonia and the fuel supplied to the sub burner may also be fuel containing liquid ammonia.

Accordingly, according to the embodiment of the present disclosure, in the combustor of the heat engine, such as a gas turbine engine or a boiler, the sub burner that can be operated under a condition under which stable combustion can be performed always is provided upstream of the main burner and fuel and air directly supplied to the main burner and a high-temperature burnt gas are mixed with each other. Therefore, the stability of combustion in the main burner can be improved. In the related art, in a case where fuel such as ammonia of which the combustible range is narrow is used, the temperature of a combustion place is decreased since a liquefied gas is directly supplied and thus it is difficult to retain a flame and to achieve stable combustion for the entire operating range corresponding to a fluctuation in load on the heat engine. However, in the present disclosure, as described above, the sub burner, which is a region to which fuel is supplied at an equivalence ratio at which combustion occurs more reliably regardless of the operating state of the heat engine, is configured upstream of the main burner and a high-temperature gas is generated through combustion in the sub burner to suppress a temperature decrease in the main burner and retain a flame. Therefore, it is possible to achieve stable combustion in a wide operating range corresponding to a fluctuation in load on the heat engine. Using the configuration according to the embodiment of the present disclosure is advantageous in a case where fuel such as a hydrogen energy carrier, of which the combustible range is narrow, is selected in a viewpoint of prevention of global warming and decarbonization.

What is claimed is:

1. A combustor of a heat engine that obtains energy through combustion of liquefied gas fuel or liquid fuel, the combustor comprising:
a tubular outer liner that includes an upstream end and a downstream end, the outer liner defining a combustion chamber that is configured such that fuel and air are supplied to the combustion chamber from an upstream end side, the fuel is subjected to combustion in the combustion chamber, and a combustion gas flows out to a downstream end side; and
a tubular inner liner that extends to be concentric with the outer liner from the upstream end side by a length shorter than a length of the outer liner inside the outer liner,
wherein the outer liner and the inner liner are configured such that a donut-shaped sub burner is defined between the outer liner and the inner liner in the combustion chamber, a main burner is defined between an end of the inner liner that is close to the downstream end and the downstream end of the outer liner, the fuel is supplied at an equivalence ratio at which a flame is retained and a combustion state is maintained throughout operation of the heat engine and is subjected to combustion in the sub burner, a burnt gas resulting from the combustion flows out to the main burner, and the fuel and the air are supplied to the main burner through a region provided radially inward of the inner liner and are subjected to combustion in the main burner while being mixed with the burnt gas from the sub burner.

2. The combustor according to claim 1, wherein an amount of the fuel supplied to the main burner is increased or decreased corresponding to a load on the heat engine.

3. The combustor according to claim 1, wherein an amount of the fuel supplied to the sub burner is determined based on a pressure and a temperature of the air supplied to the sub burner at an inlet of the sub burner.

4. The combustor according to claim 1, wherein an amount of the fuel supplied to the sub burner is determined based on an engine rotation speed of a gas turbine engine when the combustor is applied to the gas turbine engine.

5. The combustor according to claim 1, wherein the inner liner is configured such that a flow path for the fuel supplied to the sub burner is provided inside the inner liner and the fuel supplied to the sub burner is discharged to the sub burner after flowing through the flow path while being heated by heat from the sub burner.

6. The combustor according to claim 1, wherein the combustion chamber is configured such that the fuel and the air supplied to the main burner flow out to the main burner while being discharged to a preliminary room defined radially inward of the inner liner and being mixed with each other.

7. The combustor according to claim 6, wherein the preliminary room defined radially inward of the inner liner is formed such that a diameter of a downstream end that continues to the main burner is smaller than a diameter on an upstream side.

8. The combustor according to claim 1, wherein an opening area of a downstream end of the sub burner that continues to the main burner is smaller than an opening area on an upstream side.

9. The combustor according to claim 1, wherein an air hole through which air directly flows into the main burner is formed in the outer liner.

10. The combustor according to claim 1, wherein the fuel supplied to the main burner contains liquid ammonia.

11. The combustor according to claim 1, wherein the fuel supplied to the sub burner contains liquid ammonia.

12. The combustor according to claim 1, wherein the outer liner and the inner liner are formed of a heat-resistant material.

13. The combustor according to claim 1, wherein each of the outer liner and the inner liner has a cylindrical shape.

14. The combustor according to claim 1 further comprising an ignition plug provided in the sub burner.
